(19) United States
(12) Patent Application Publication
(10) Pub. No.: US 2017/0139584 A1
(43) Pub. Date: May 18, 2017

(54) USER ACCOUNT SWITCHING INTERFACE

(71) Applicant: HEWLETT-PACKARD DEVELOPMENT COMPANY, L.P., HOUSTON, TX (US)

(72) Inventors: SOMA SUNDARAM SANTHIVEERAN, PALO ALTO, CA (US); ROY GAURAV, PUNE (IN); ASHISH RAJ, PUNE (IN); AMAR BALUTKAR, PUNE (IN)

(73) Assignee: Hewlett-Packard Development Company, L.P., Houston, TX (US)

(21) Appl. No.: 15/306,571

(22) PCT Filed: May 29, 2014
(86) PCT No.: PCT/IN2014/000361

§ 371 Date: Oct. 25, 2016

(51) Int. Cl. G06F 3/0488; G06F 3/0483; G06F 3/0481

(52) U.S. Cl. CPC G06F 3/04883; G06F 3/04817; G06F 3/0483

(57) ABSTRACT

Example implementations relate to switching user accounts. For example, a method includes displaying, at a display of a mobile device, a first user account. The method also includes displaying a first user account switching interface on a first side of the display, the first user account switching interface to indicate a second user account. The method further includes, in response to detecting a gesture input associated with the first user account switching interface, displaying the second user account and displaying a second user account switching interface on a second side of the display that is opposite to the first side of the display. The second user account switching interface to indicate the first user account.

### BACKGROUND

Mobile devices, such as smart phones or tablet computing devices, are becoming prevalent. In addition to being used for personal purposes, mobile devices are also used for work-related purposes, such as checking e-mails or editing documents.

### BRIEF DESCRIPTION OF THE DRAWINGS

Some examples of the present application are described with respect to the following figures:

FIGS. 1A-1B illustrate an example mobile device including an example user account switching interface;

FIGS. 2A-2C illustrate an example method of switching user accounts sequentially using user account switching interfaces;

FIGS. 3A-3C illustrates an example method of switching user accounts sequentially in a circular manner using user account switching interfaces;

FIGS. 4A-4D illustrate another example method of switching user accounts sequentially in a circular manner using user account switching interfaces;

FIGS. 5A-5C illustrate an example method of switching user accounts using a single user account switching interface;

FIG. 6 is a block diagram of an example mobile device for switching user accounts using user account switching interfaces; and

FIG. 7 is an example of a flowchart illustrating an example method of switching user accounts using user account switching interfaces.

### DETAILED DESCRIPTION

As described above, mobile devices may be used for multiple purposes, such as personal purpose and work purpose. However, for security reasons, a user may have a separate mobile device for each purpose. Thus, the equipment ownership cost is increased as multiple mobile devices are used for multiple purposes.

Examples described herein address the above challenges by providing a user account switching interface that enables a user to switch between multiple user accounts so that a single mobile device may be used for multiple purposes. For example, when a first user account is shown on a display of a mobile device, a first user account switching interface may be displayed on a side of the display, such as the left side or the right side. The first user account switching interface may indicate a second user account that is not currently displayed. In response to detecting a gesture input associated with the first user account switching interface, such as a horizontal swipe, a processor of the mobile device may cause the display to not display the first user account and to display the second user account. When the second user account is displayed, a second user account switching interface indicating the first user account may be displayed. Thus, a user of the mobile device may switch between the first user account and the second user account using a single gesture input. In this manner, examples described herein may reduce an equipment ownership cost.

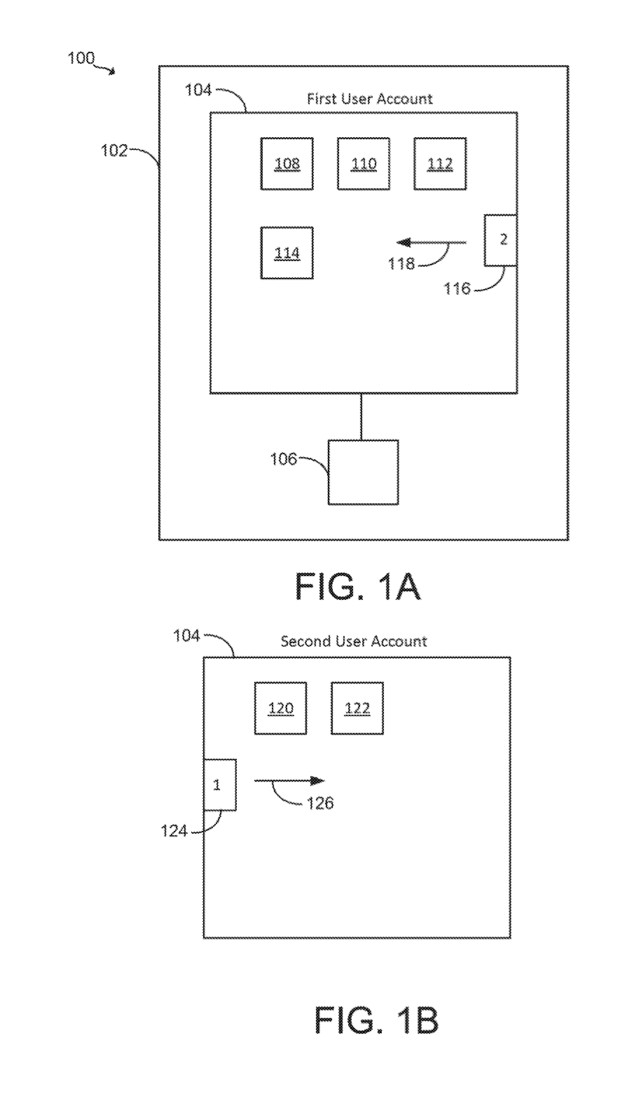

Referring now to the figures, FIGS. 1A-1B illustrate an example mobile device 100 including an example user account switching interface. Mobile device 100 may be, for example, a smartphone, a tablet computing devices, a notebook computer, an electronic book reader, or any other electronic device suitable for switching user accounts using at least one user account switching interface.

As illustrated in FIG. 1A, mobile device 100 may include a housing 102, a display 104, and a processor 106. Display 104 may be an electronic device suitable for visual presentation of data. For example, display 104 may be a touchscreen so that mobile device 100 may receive input from a user via display 104. Processor 106 may be a central processing unit (CPU), a semiconductor-based microprocessor, and/or other hardware devices suitable for retrieval and execution of instructions stored in computer-readable storage medium (not shown). Processor 106 may control display 104 using processor executable instructions. Mobile device 100 may include two user accounts, a first user account and a second user account.

In FIG. 1A, the first user account may be displayed on display 104. As used herein, a user account is a profile that defines or customizes various parameter values of a user interface of mobile device 100. For example, a user account may define what applications (e.g., processor executable instructions) may run mobile device 100 and/or be accessible to a user of mobile device 100. As another example, a user account may also define data that may be accessible to a user of mobile device 100. In some examples, a user account may be referred to as a persona.

When the first user account is displayed, content of the first user account may be displayed. For example, icons representing applications may be displayed on display 104, such as icons 108-114. Each of icons 108-114 may represent a distinct application (e.g., processor executable instructions) that is installed on mobile device 100 and is accessible to a user of mobile device 100. In some examples, the first user account may correspond to a user account for use at home by a user of mobile device 100.

A first user account switching interface 116 may be displayed on display 104 when the first user account is displayed. As used herein, a user account switching interface may be a visual representation of a point of interaction between a user and mobile device 100 for switching user accounts. First user account switching interface 116 may indicate an available user account that is not currently displayed, such as the second user account. For example, first user account switching interface 116 may be a pattern. The pattern may include a tab displayed on the right side of display 104. The tab may indicate the second user account via a number, such as “2.” In some examples, the tab may display a symbol or a letter to indicate the second user account. In some examples, an indication of a user account may be configurable via a user input. For example, a user may configure the Indication such that a number is used to indicate a user account in first user account switching interface 116. As another example, a user may configure the indication such that a letter is used to indicate a user account in first user account switching interface 116.

First user account switching interface 116 may be displayed on a side of display 104, such the right side of display 104. Although first user account switching interface 116 is displayed on the right side of display 104 in FIG. 1A, it should be understood that first user account switching interface 116 may be displayed on any side of display 104.

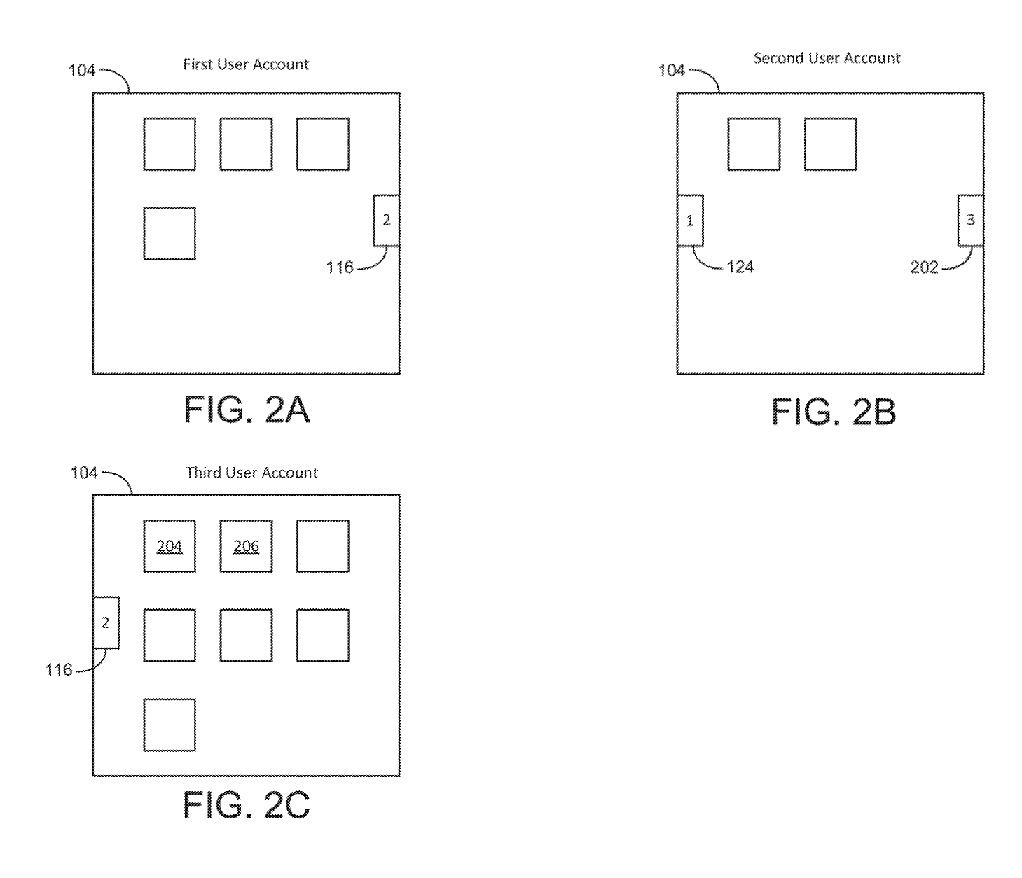

During operation, when processor 106 detects a gesture input associated with first user account switching interface 116 via display 104, processor 106 may cause display 104 to display the second user account and a second user account switching interface 124. Processor 106 may also cause display 104 to not display the first user account and to not display first user account switching interface 116. The second user account is described in more detail in FIG. 2B. As an example, the gesture input associated with first user account switching interface 116 may correspond to a horizontal movement of an input device, such as a stylus, in a first direction (as indicated by an arrow 118) from a first region of display 104 where first user account switching interface is displayed to a second region outside of the first region.

FIG. 1B illustrates the second user account displayed on display 104. In some examples, the second user account may correspond to a user account for use at work. The second user account may include content, such as applications or data, different from the first user account. For example, the second user account may include icons 120-122. Each of icons 120-122 may represent a distinct application. Second user account switching interface 124 may also be displayed on display 104 when the second user account is displayed. Second user account switching interface 124 may be displayed on a side of display 104 opposite to first user account switching interface 116. For example, second user account switching interface 124 may be displayed on the left side of display 104 when first user account switching interface 116 is displayed on the right side of display 104. Second user account switching interface 124 may indicate the first user account via a number, such as “1,” a symbol, or a letter.

During operation, to switch from the second user account to the first user account, a user may provide a gesture input associated with second user account switching interface 124 by moving an input device horizontally in a second direction (as indicated by an arrow 126) from a third region of display 104 where second user account switching interface 124 is displayed to another region outside of the third region. The second direction may be opposite to the first direction. In some examples, a user may move the input device horizontally in the first direction to switch from the second user account to the first user account. In response to detecting the gesture input, processor 106 may cause display 104 to display the first user account and first user account switching interface 116. Processor 106 may also cause display 104 to not display the second user account and to not display second user account switching interface 124.

Thus, a user of mobile device 100 may switch between the first user account and the second user account via a single gesture input. When mobile device 100 includes more than two user accounts, user accounts may be switched sequentially. Sequentially switching among multiple user accounts is described in more detail in FIGS. 2A-4D.

FIGS. 2A-2C illustrate an example method of switching user accounts sequentially using user account switching interfaces. The example method illustrated in FIGS. 2A-2C may be implemented using mobile device 100 of FIG. 1A. In the example method illustrated in FIGS. 2A-2C, mobile device 100 may include three user accounts: the first user account, the second user account, and a third user account. The user accounts may be displayed according to a display sequence. For example, the first user account may be displayed prior to the second user account and the second user account may be displayed prior to the third user account. In some examples, the display sequence may be arranged based on a priority of each user account. For example, the first user account may have a first priority, the second user account may have a second priority that is lower than the first priority, and the third user account may have a third priority that is lower than the second priority. In some examples, the display sequence may be configured via a user input. Thus, a user may switch among the first user account, the second user account, and the third user account sequentially according to a display sequence.

In FIG. 2A, the first user account may be displayed on display 104. First user account switching interface 116 may also be displayed on display 104. First user account switching interface 116 may indicate the second user account that is arranged to be displayed immediately subsequent to the first user account. However, since there is no user account that is arranged to be displayed prior to the first user account, only first user account switching interface 116 is displayed when the first user account is displayed.

In FIG. 2B, in response to detecting a gesture input, processor 106 of FIG. 1A may cause display 104 to display the second user account. When the second user account is displayed, second user account switching interface 124 and a third user account switching interface 202 may also be displayed. User account switching interfaces 124 and 202 may indicate neighboring user accounts of the second user. Second user account switching interface 124 may indicate the first user account that is arranged to be displayed prior to the second user account. Third user account switching interface 202 may indicate the third user account that is arranged to be displayed immediately subsequent to the second user account according to a display sequence.

Second user account switching interface 124 may be displayed on a first side of display 104 and third user account switching interface 202 may be displayed on a second side of display 104 that is opposite to the first side. For example, second user account switching interface 124 may be displayed on the left side of display 104 and third user account switching interface 202 may be display on the right side of display 104. To switch back to the first user account, a user of mobile device 100 may provide a gesture input associated with second user account switching interface 124. To switch to the third user account, the user may provide a gesture input associated with third user account switching interface 202. The third user account is described in more detail in FIG. 2C.

In FIG. 2C, the third user account may be displayed on display 104. Content of the third user account may also be displayed, such as icons 204-206. Each of icons 204-206 may represent a distinct application that is accessible to the third user account. First user account switching interface 116 may also be displayed on a side of display 104 when the third user account is displayed. However, since there is no other user account arranged to be displayed subsequent to the third user account, no user account switching interface is displayed on the opposite side of first user account switching interface 116.

In some examples, an association between a user account switching interface and a user account may be configured via a user input. For example, first user account switching interface 116 may be configured via a user input so that first user account switching interface 116 may indicate the third user account instead of the second user account.

Thus, a user of mobile device 100 may switch among the user accounts sequentially from the first user account to the second user account and from the second user account to the third user account. However, the user may not switch from the first user account directly to the third user account. Although FIGS. 2A-2C illustrate three user accounts, it should be understood that mobile device 100 may include any number of user accounts.

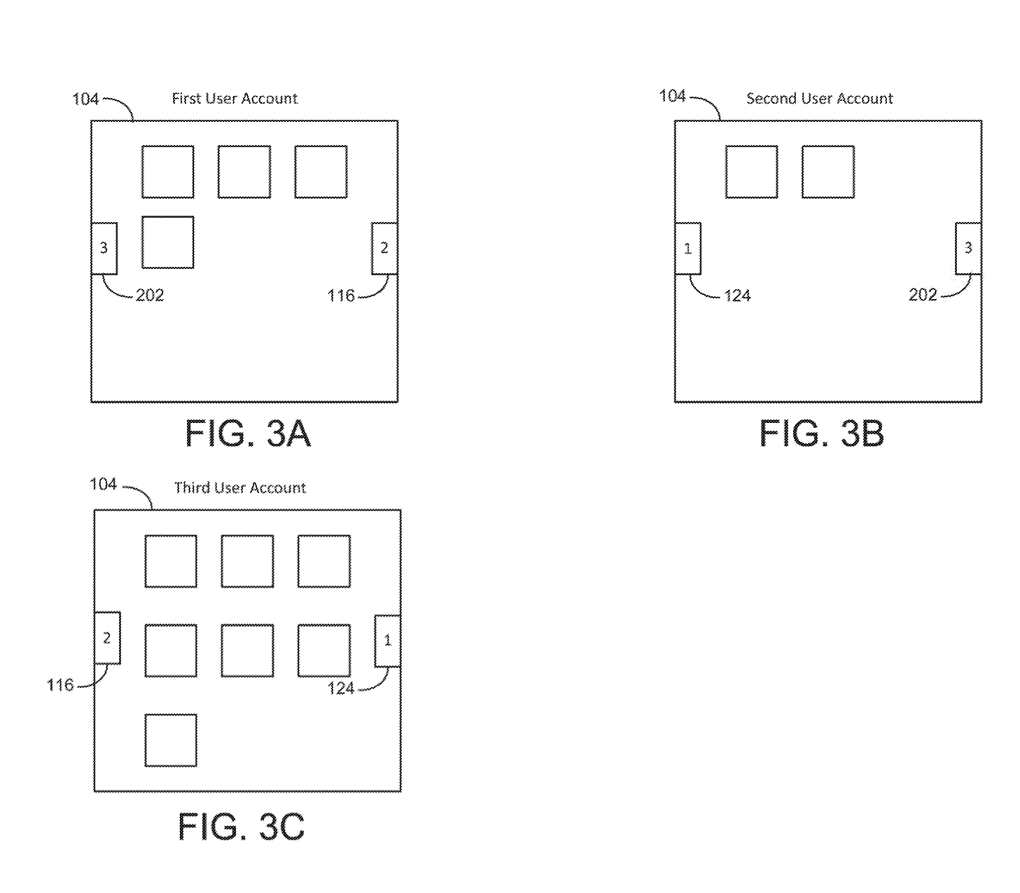

FIGS. 3A-3C illustrates an example method of switching user accounts sequentially in a circular manner using user account switching interfaces. The example method illustrated in FIGS. 3A-3C may be implemented using mobile device 100 of FIG. 1A. In the example method illustrated in FIGS. 3A-3C, mobile device 100 may include three user accounts: the first user account, the second user account, and the third user.

In FIG. 3A, the first user account may be displayed. User account switching interfaces indicating neighboring user accounts of the first user account may also be displayed. A single user account switching interface indicating a distinct neighboring user account of the first user account may be displayed each side of display 104. For example, third user account switching interface 202 indicating the third user account may be displayed on the left side of display 104. First user account switching interface 116 indicating the second user account may be displayed on the right side of display 104.

In FIG. 3B, in response to detecting a gesture input associated first user account switching interface 116, the second account may be displayed on display 104. User account switching interfaces indicating neighboring user accounts of the second user account may also be displayed. For example, second user account switching interface 124 may be displayed on the left side of display 104 and third user account switching interface 202 may be displayed on the right side of display 104. Thus, a user may switch back to the first user account or switch to the third user account via user account switching interfaces 124 or 202, respectively, when the second user account is displayed.

In FIG. 3C, in response to detecting a gesture input associated with third user account switching interface 202, the third user account may be displayed. User account switching interfaces indicating neighboring user accounts of the third user account may also be displayed. For example, first user account switching interface 116 may be displayed on the left side of display 104 and second user account switching interface 124 may be displayed on the right side of display 104. Thus, a user may switch back to the first user account or switch to the second user account via user account switching interface 116 or 124, respectively, when the third user account is displayed. Accordingly, a user of mobile device 100 may switch among the three user accounts sequentially in a circular manner.

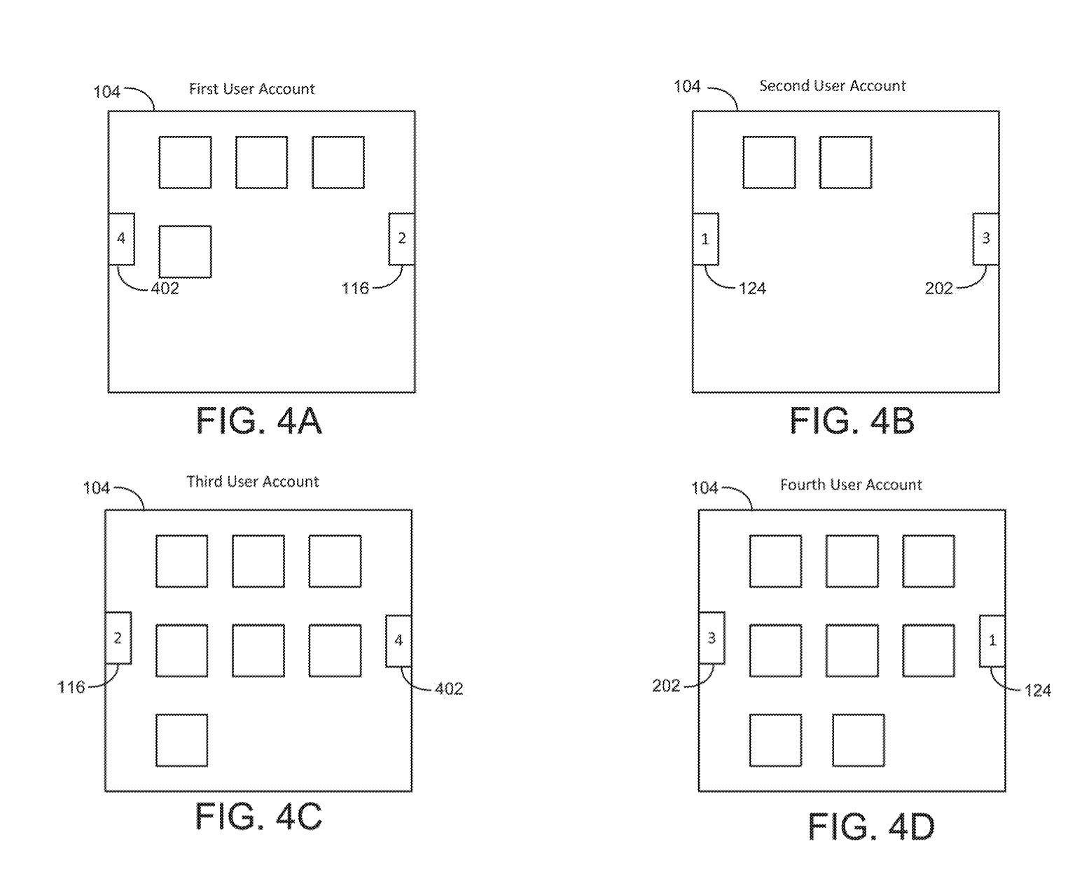

FIGS. 4A-4D illustrate another example method of switching user accounts sequentially in a circular manner using user account switching interfaces. The example method in FIGS. 4A-4D may be implemented using mobile device 100 of FIG. 1A. In the example method illustrated in FIGS. 4A-4D, mobile device 100 may include four user accounts: the first user account, the second user account, the third user account, and the fourth user account. In FIG. 4A, the first user account may be displayed on display 104. User account switching interfaces indicating neighboring user accounts of the first user account may also be displayed. For example, a fourth user account switching interface 402 indicating the fourth user account may be displayed on the left side of display 104. First user account switching interface 116 indicating the second user account may be displayed on the right side of display 104.

In FIG. 4B, in response to a gesture input associated with first user account switching interface 116, the second user account may be displayed on display 104. User account switching interfaces indicating neighboring user accounts of the second user account may also be displayed. For example, second user account switching interface 124 indicating the first user account may be displayed on the left side of display 104. Third user account switching interface 202 indicating the third user account may be displayed on the right side of display 104.

In FIG. 4C, in response to a gesture input associated with third user account switching interface 202, the third user account may be displayed on display 104. User account switching interfaces indicating neighboring user accounts of the third user account may also be displayed. For example, first user account switching interface 116 indicating the first user account may be displayed on the left side of display 104. Fourth user account switching interface 402 indicating the fourth user account may be displayed on the right side of display 104.

In FIG. 4D, in response to a gesture input associated with fourth user account switching interface 402, the fourth user account may be displayed on display 104. User account switching interfaces indicating neighboring user accounts of the fourth user account may also be displayed. For example, third user account switching interface 202 indicating the third user account may be displayed on the left side of display 104. Second user account switching interface 124 indicating the first user account may be displayed on the right side of display 104. Thus, a user of mobile device 100 may sequentially switch among the four user accounts in a circular manner. Although FIGS. 4A-4D illustrate four user accounts, it should be understood that mobile device 100 may include any number of user accounts.

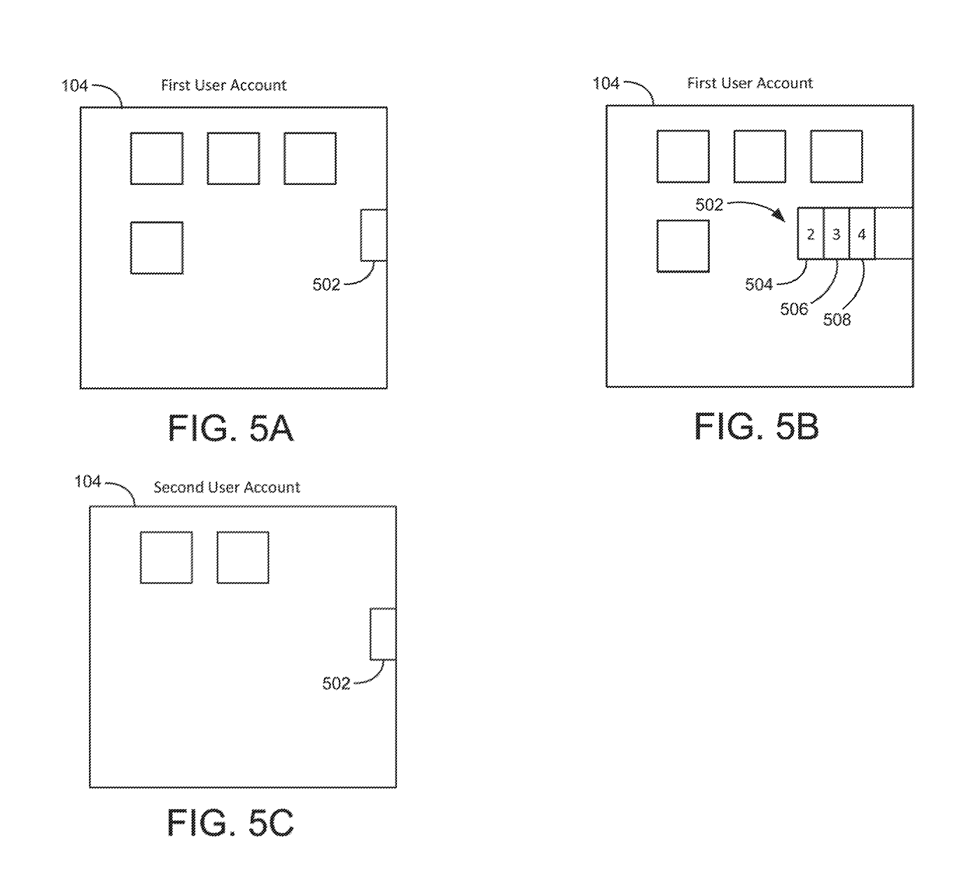

FIGS. 5A-5C illustrate an example method of switching user accounts using a single user account switching interface. The example method illustrated in FIGS. 5A-5C may be implemented using mobile device 100 of FIG. 1A. In FIG. 5A, a first user account may be displayed on display 104. A user account switching interface 502 may also be displayed on display 104. User account switching interface 502 may be displayed on a side of display 104, such as the right side. As described in more detail in FIG. 5B, a user of mobile device 100 may switch among available user accounts using user account switching interface 502.

In FIG. 5B, in response to a gesture input associated with user account switching interface 502, user account switching interface 502 may expand to show multiple representations associated with available user accounts that are not currently displayed. For example, user account switching interface 502 may expand to show representation 504 indicating a second user account, representation 506 indicating a third user account, and representation 508 indicating a fourth user account. As described in more detail in FIG. 5C, to switch to an available user account that is not currently displayed, a user may provide a gesture input associated with a corresponding user account switching interface.

In FIG. 5C, in response to a gesture input associated with representation 504, the second user account may be displayed on display 104. User account switching interface 502 may also be displayed on display 104. Thus, a user may expand user account switching interface 502 to switch to other user accounts from the second user account.

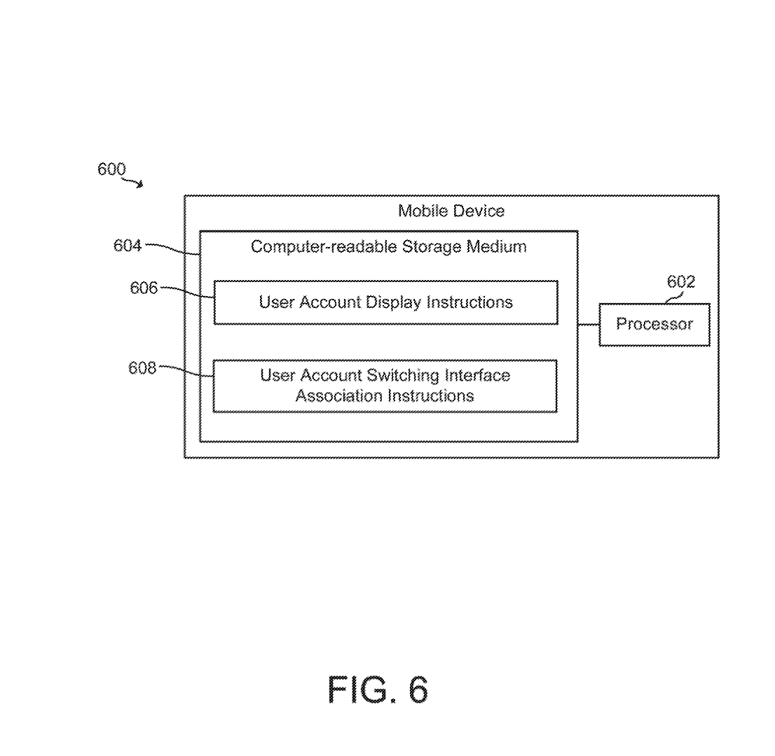

FIG. 6 is a block diagram of an example mobile device 600 for switching user accounts using user account switching interfaces. Mobile device 600 may be similar to mobile device 100 of FIG. 1A. Mobile device 600 may include a processor 602 and a computer-readable storage medium 604. Processor 602 may be a central processing unit (CPU), a semiconductor-based microprocessor, and/or other hardware devices suitable for retrieval and execution of instructions stored in computer-readable storage medium 604. Processor 602 may fetch, decode, and execute instructions 606 and 608 to control a process of switching user accounts via user account switching interfaces. As an alternative or in addition to retrieving and executing instructions, processor 602 may include at least one electronic circuit that includes electronic components for performing the functionality of instructions 606, 608, or a combination thereof.

Computer-readable storage medium 604 may be any electronic, magnetic, optical, or other physical storage device that contains or stores executable instructions. Thus, computer-readable storage medium 604 may be, for example, Random Access Memory (RAM), an Electrically Erasable Programmable Read-Only Memory (EEPROM), a storage device, an optical disc, etc. In some examples, computer-readable storage medium 604 may be a non-transitory storage medium, where the term “non-transitory” does not encompass transitory propagating signals. As described in detail below, computer-readable storage medium 604 may be encoded with a series of processor executable instructions 606 and 608 for switching user accounts using user account switching interfaces.

User account display instructions 606 may cause a display, such as display 104 of FIG. 1A, to display a user account including content of the user account. User account display instructions 606 may also cause the display to display at least one user account switching interface on the display. User account switching interface association instructions 608 may generate an association between a user account switching interface and a user account. For example, user account switching interface association instructions 608 may associate the first user account of FIG. 1A to second user account switching interface 124 of FIG. 1B.

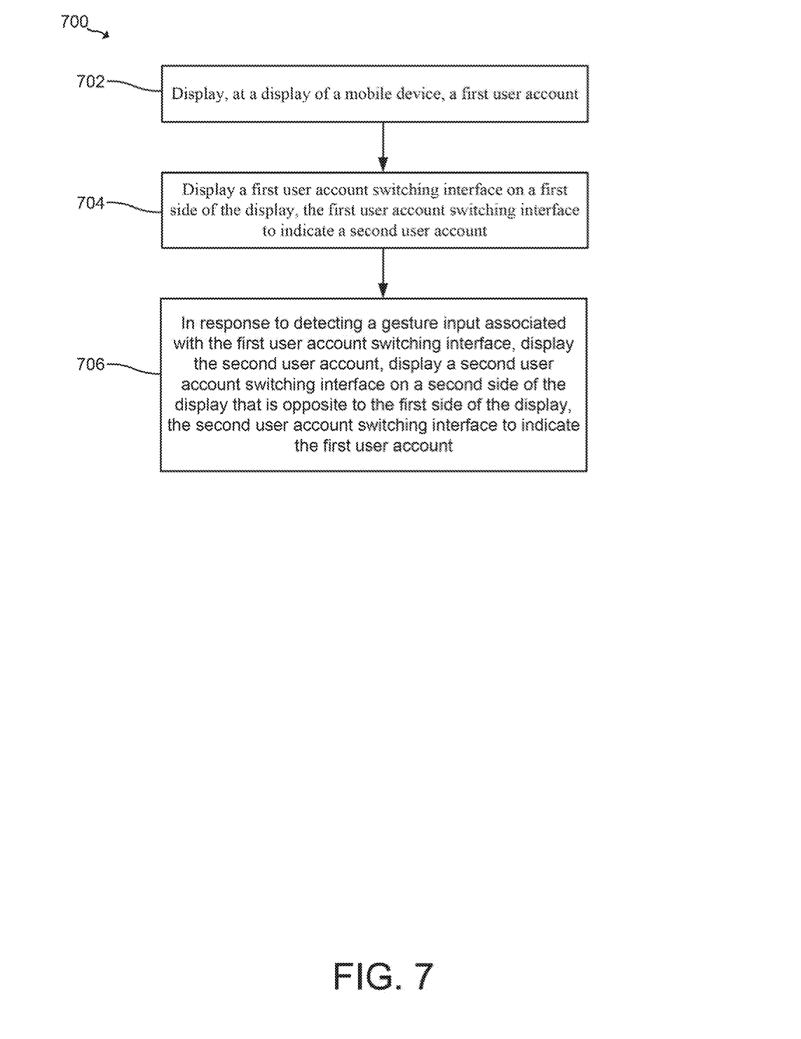

FIG. 7 is an example of a flowchart illustrating an example method 700 of switching user accounts using user account switching interfaces. Method 700 may be implemented using mobile device 100 of FIG. 1A and/or mobile device 600 of FIG. 6. Method 700 includes displaying, at a display of a mobile device, a first user account, at 702. For example, referring to FIG. 2A, the first user account may be displayed on display 104. Method 700 also includes displaying a first user account switching interface on a first side of the display, the first user account switching interface to indicate a second user account, at 704. For example, referring to FIG. 2A, first user account switching interface 16 may be displayed on display 104. Method 700 further includes in response to detecting a gesture input associated with the first user account switching interface, displaying the second user account and displaying a second user account switching interface on a second side of the display that is opposite to the first side of the display, the second user account switching interface to indicate the first user account, at 706. For example, referring to FIG. 2B, the second user account may be displayed on display 104. Second user account switching interface 124 may be displayed on the left side of display 104 and third user account switching interface 202 may be displayed on the right side of display 104. Second user account switching interface 124 to indicate the first user account and third user account switching interface 202 to indicate the third user account.

The use of “comprising”, “including” or “having” are synonymous and variations thereof herein are meant to be inclusive or open-ended and do not exclude additional unrecited elements or method steps.

What is claimed is:

1. A method comprising:
displaying, at a display of a mobile device, a first user account;
displaying a first user account switching interface on a first side of the display, the first user account switching interface to indicate a second user account; and
in response to detecting a gesture input associated with the first user account switching interface:
displaying the second user account; and
displaying a second user account switching interface on a second side of the display that is opposite to the first side of the display, the second user account switching interface to indicate the first user account.

2. The method of claim 1, further comprising:
in response to detecting the gesture input associated with the first user account switching interface, displaying a third user account switching interface on the first side of the display, the third user account switching interface to indicate a third user account; and
in response to detecting a second gesture input associated with the third user account switching interface:
displaying the third user account; and
displaying the second user account switching interface on the second side of the display, wherein the first user account switching interface is not displayed.

3. The method of claim 2, wherein a single user account switching interface is displayed when the first user account or the third user account is displayed.

4. The method of claim 2, wherein the first user account, the second user account, and the third user account are displayed sequentially.

5. The method of claim 2, wherein the first side of the display corresponds to one of a left side of the display and a right side of the display, and wherein the second side of the display corresponds to the other of the left side and the right side.

6. The method of claim 1, wherein the gesture input corresponds to a single horizontal swipe.

7. The method of claim 1, wherein the first user account switching interface corresponds to a pattern, the pattern includes a tab to indicate the first user account.

8. An apparatus comprising:
a display; and
a processor to:
cause the display to display a first user account switching interface on one of a left side of the display and a right side of the display, the first user account switching interface to indicate a second user account; and
cause the display to display a second user account switching interface on the other of the left side and the right side, the second user account switching interface to indicate a third user account.

9. The apparatus of claim 8, the processor further to:
in response to detecting a gesture input associated with the first user account switching interface:
cause the display to display the second user account;
cause the display to display a second user account switching interface on one of the left side and the right side, the second user account switching interface to indicate the first user account; and
cause the display to display a third user account switching interface on the other of the left side and the right side, the third user account switching interface to indicate the third user account.

10. The apparatus of claim 8, the processor further to:
in response to detecting a gesture input associated with one of the first user account switching interface and the second user account switching interface:
cause the display to display one of the second user account and the third user account; and
cause the display to display a single user account switching interface on one of the left side of the display and the right side of the display, the single user account switching interface to indicate the first user account.

11. The apparatus of claim 8, the processor further to associate the first user account switching interface to a user account different from the first user account in response to a user input.

12. The apparatus of claim 8, wherein the first user account, the second user account, and the third user account are arranged to be displayed according to a display sequence.

13. A computer-readable storage medium comprising instructions that when executed cause a processor of a mobile device to:
cause a display of the mobile device to display a first user account;
cause the display to display a first user account switching interface on one of a left side of the display and a right side of the display, the first user account switching interface to indicate a second user account;
cause the display to display a second user account switching interface on the other of the left side and the right side, the second user account switching interface to indicate a third user account;
in response to detecting a gesture input associated with the first user account switching interface:
cause the display to display the second user account;
cause the display to display a third user account switching interface on one of the left side and the right side, the third user account switching interface to indicate the first user account; and
cause the display to display the second user account switching interface opposite to the third user account switching interface.

14. The computer-readable storage medium of claim 13, wherein the first user account and the third user account are neighbouring user accounts to the second user account according to a display sequence.

15. The computer-readable storage medium of claim 13, wherein the first user account switching interface corresponds to a tab, the tab includes a pattern to indicate the second user account.
